(19) United States
(12) Patent Application Publication
(10) Pub. No.: US 2026/0151293 A1
(43) Pub. Date: Jun. 4, 2026

(54) ERGONOMIC, SMART EROTIC DEVICE, WITH THE REALISTIC APPEARANCE OF A PHALLUS, ADAPTED FOR EJECTING A LIQUID BY SIMULATING AN ACT OF EJACULATION

(71) Applicant: Patrik SPIRIDIGLIOZZI, CASTROCIELO (FR) (IT)

(72) Inventor: Patrik SPIRIDIGLIOZZI, CASTROCIELO (FR) (IT)

(21) Appl. No.: 19/122,622

(22) PCT Filed: Nov. 6, 2023
(86) PCT No.: PCT/IB2023/061158

§ 371 Date: Apr. 18, 2025

(30) Foreign Application Priority Data
Nov. 14, 2022 (IT) 102022000023376

(51) Int. Cl. A61H 19/00

(52) U.S. Cl. CPC A61H 19/44; A61H 2201/0207; A61H 2201/105; A61H 2201/5097

(57) ABSTRACT

Device for erotic use, having the appearance of a realistic phallus, adapted for ejecting a liquid in order to simulate an ejaculatory act, taking on a realistic appearance and consistency and simulating an erectile and post-erectile phase comprising:—a central rod (2) with cavernous element (2.1), which allows the passage of liquid through soft cavernous weaves, capable of deforming;—a liquid ejection module (1), comprising an aperture (1.1) positioned at the upper end of two overlapping cusps (1.2), connected to the cavernous element (2.1), adapted to retain liquid allowing a controlled release thereof;—a lower tank (3), comprising an internal bag (3.1) containing liquid, a motor (3.4) with micro-pump (3.5) having a first end (3.2), adapted to suck liquid and a second end (3.3), adapted to inject liquid internally to said cavernous element (2.1); a recharge micro-cap (3.6); said ejection being activated by exerting mechanical pressure on the cavernous element (2.1) towards the motor (3.4).

### FIELD OF THE INVENTION

The present invention relates to the field of technical products and supplies for erotic purposes. In more detail, the subject of this patent application is a new synthetic penis for ejecting a liquid, programmed to simulate a realistic act of ejaculation.

### PRIOR ART

In the prior art, a variety of erotic, realistic-like products for personal use, exhibition use and for shows aimed at the public are known. These are a variety of devices, from those whose operation is relatively simple, usually battery operated, to the more complex and remotely controlled ones designed for a variety of purposes. There are also wearable ones, of a plurality of designs and quality, suitable for the most varied uses.

Speaking of patents, the area has been explored in depth and there are several. According to patent WO2014043263A1, the sex toy device is useful for the sexual stimulation of the user, includes a flexible sleeve and an expandable ring configured to translate on the sleeve along the longitudinal axis and change in diameter to vary the amount of constriction applied on the sleeve.

Instead, document EP2995292A2 claims a device for sexual well-being and/or for providing sexual stimulation, which has a pressure sensor fluidly coupled to a fitting and a controller coupled to the pressure sensor and to the battery.

Finally, patent U.S. Pat. No. 7,163,508B1 describes an insertable device for sexual use, which provides for the ejection of lubricant, with a dispensing unit comprising a compressed air plunger to exert pressure on the piston, so as to move it along the shaft through a hole to force lubricant through the head outlet port.

This device, however, lacks a realistic appearance both before and after the liquid ejection. Ultimately, none of the devices mentioned above or currently on the market are able to provide the ejection of liquid that simulates a real ejaculation, taking on a realistic appearance and simulating the erectile and post-ejaculation phase.

Therefore, the object of the present invention is to solve the problems set out above.

### DESCRIPTION OF THE INVENTION

According to the present invention, a new device for erotic use is created, with a realistic appearance of a phallus, designed to eject liquid in such a way as to simulate an act of ejaculation, taking on a realistic appearance and consistency and simulating an erectile and post-erectile phase.

The device in question includes several modules described below:
1) A central rod, phallic in shape, connected above to a liquid ejection module and to a lower tank, comprising:
   an internal cavernous element, which crosses the entire rod lengthwise from bottom to top, allowing the flow of liquid;
   soft cavernous weaves, surrounding the walls of said cavernous element which, being soft, deform in order to simulate the physical behavior of the erection phases with increase in volume and loss of volume post-ejaculation.

The latter is one of the main advantages of the device in question, which, structured in this way, appears to behave like a real penis, completely taking on the appearance thereof.
2) A liquid ejection module, in the shape of a glans, which includes:
   at least one aperture, reversibly openable, positioned at the upper end of the entire device, which allows the liquid contained in the device to be ejected;
   at least two overlapping cusps, connected to said cavernous element and which retain liquid internally, allowing, at a later time, a controlled ejection of liquid.
3) A lower tank, shaped like a scrotum, which behaves similarly to the aforementioned central rod, reducing its volume once emptied. It includes:
   at least one internal bag to contain the liquid;
   at least one motor, positioned at the upper end of the tank which activates the transfer of liquid from said internal bag towards the cavernous element;
   a micropump contained in said motor with a first lower end which sucks the liquid contained in the bag and a second upper end which injects the liquid internally into the aforementioned cavernous element;
   at least one reversibly extractable battery which allows the operation of the aforementioned motor;
   a watertight micro-cap, placed underneath the entire tank, for refilling the liquid.

One of the advantages of the present invention is that of providing an external surface that entirely covers the device, preferably made of soft silicone rubber, resulting extremely realistic. It includes an on/activation button for the aforementioned motor via on/off input which starts the aforementioned installed motor.

The ejection of liquid, advantageously, is activated by exerting a mechanical stress on said cavernous element, with a continuous movement from top to bottom, which consequently exerts pressure on said motor allowing its activation and a rise of liquid towards the cavernous element. Once the aforementioned liquid rises upwards and reaches the aforementioned liquid ejection module, it will exit through the aforementioned aperture.

Furthermore and advantageously, the device includes at least one rechargeable battery and at least one related snap-fit charger provided with LED lights indicating the battery charge status. In an advantageous and preferred version, the aforementioned central rod internally includes at least three cavernous elements which, in this configuration, guarantee a triple pressure above the motor and guarantee an even more realistic appearance to the device described so far.

The aforementioned external surface, in further versions:
incorporates a plurality of micro-LEDs which make the external surface bright and variable in color;
it is transparent in color and/or the color can be customized by each user.

Furthermore, the tank described above advantageously contains drinking liquid, being able to vary its taste upon selection by a user.

The aforementioned liquid ejection module, rod and tank in advantageous versions include:
watertight gaskets at the connections between them which make the device in question completely waterproof;
a plurality of resistors, uniformly distributed, which heat said external surface of said device;
a plurality of resistors designed to heat the liquid contained, allowing it to be ejected at a controlled temperature.

Advantageously, furthermore, the device includes wireless connection means to any portable electronic device such as smartphones or the like which, once provided with a dedicated software application included in a version of the present invention, will allow managing at least the quantity and temperature of the liquid to be ejected, the softness or hardness of the entire device and its external temperature.

Furthermore, the user will be able to communicate with at least one Bluetooth speaker advantageously integrated into a possible further version of the device in question.

Possibly and advantageously it will include at least one sensor adapted to check the quantity of liquid remaining in the tank and signaling its possible absence by turning on a warning light.

The advantages of the present invention are clear in the light of the above description and will be even apparent from the following detailed description and accompanying FIGURE.

### DESCRIPTION OF THE FIGURES

The invention will hereinafter be described in at least one preferred embodiment thereof by way of non-limiting example with the aid of the accompanying FIGURE, in which:

FIG. 1 shows the device for erotic use in question, having a liquid ejection module 1 which includes at least two overlapping cusps 1.2 and an aperture 1.1; connected inferiorly to module 1, a central rod 2 may be seen, including in its interior three cavernous elements 2.1 surrounded by soft cavernous weaves. Finally, the tank 3 includes an internal bag 3.1 for containing liquid and is installed below the rod 2. It is refillable via a micro-cap 3.6 and comprises a motor 3.4 having a pump 3.5 having a suction end 3.2 and an end 3.3 suitable for injecting liquid. Finally, note the external surface 5 which integrates an on/off activation button.

### DETAILED DESCRIPTION OF THE INVENTION

The present invention will now be described purely by way of non-limiting or binding example with the aid of the FIGURE, which illustrate some embodiments relative to the present inventive concept.

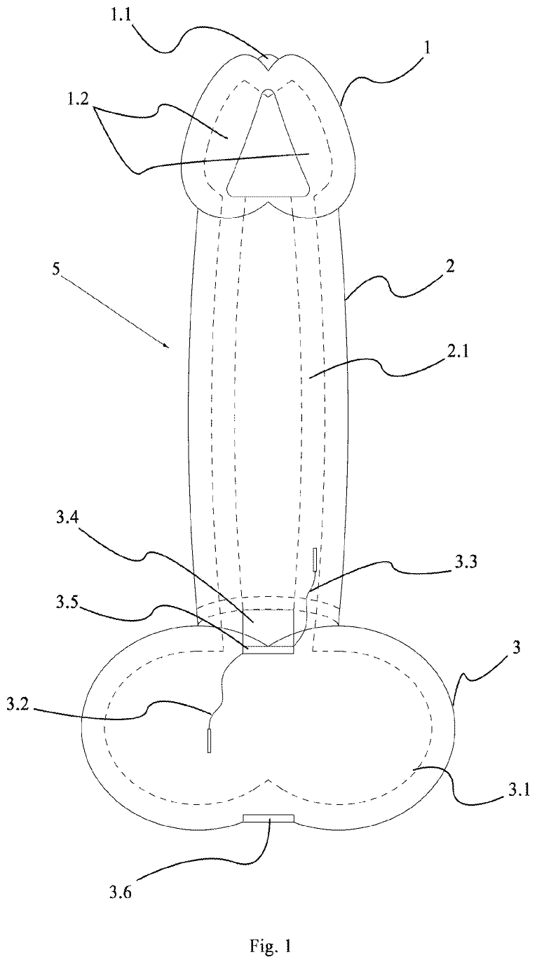

With reference to FIG. 1, the set of components of the device for erotic use, with the realistic appearance and consistency of a phallus, is shown in a preferred version in which it is structured in: a liquid ejection module 1 having the shape of the glans, a central rod 2 having phallic shape and a lower tank 3 having the shape of a scrotum.

The aforementioned liquid ejection module 1, positioned at the upper end of the device, is provided with a reversibly openable aperture 1.1, which allows the ejection of a drinking liquid contained inside the tank 3, simulating an ejaculation.

At least two overlapping cusps 1.2 are installed inside the module 1 which, being connected to cavernous elements 2.1, allow the flow of the aforementioned liquid up to the aperture 1.1. They initially retain the liquid internally, swelling and subsequently allow the controlled ejection of said liquid.

Again FIG. 1 shows the central rod 2 which internally includes at least three aforementioned cavernous elements 2.1, surrounded by soft cavernous weaves, and which allow a triple pressure to be exerted towards a motor 3.4 contained in the tank 3 in order to activate the ejection of liquid. These elements, when the passage of liquid upwards occurs, increase their volume simulating an erection while once emptied, they reduce in volume simulating a loss of turgor.

To complete the device at the bottom, there is the aforementioned tank 3 which performs the function of containing liquid, after ejecting the same and similarly to said central rod 2 it reduces its volume once emptied. It is designed to contain an internal bag 3.1 which is, from time to time, filled with liquid via a watertight micro-cap 3.6.

The motor 3.4 mentioned above is positioned below said rod 2 and at the upper end of the tank 3, powered by at least one rechargeable battery, it mobilizes the transfer of liquid from the internal bag 3.1 to the cavernous element 2.1 by means of a micro-pump 3.5: this is divided into a first end 3.2 and a second end 3.3.

The first 3.2, placed below the motor 3.4, sucks the liquid contained in the bag 3.1 while the second 3.3, placed above the motor 3.4, injects the liquid inside the cavernous elements 2.1. Through the execution of a continuous movement from top to bottom, as mentioned, the pressure of said central rod 2 is exerted towards the motor 3.4 and the ejection of said liquid through said liquid ejection module 1 is stimulated. Watertight gaskets are installed at the connection points between the aforementioned liquid ejection module, the rod and the tank 1-2-3: this feature makes the device completely waterproof.

The entire body of the device is surrounded by an external surface 5, preferably made of soft silicone rubber, which incorporates a motor activation button 3.4 and a plurality of micro-LEDs, becoming bright and variable in color at will.

Furthermore, a plurality of resistors is uniformly distributed across the entire internal and external surface of the device. They allow:
the heating of the contained liquid so that a user can vary the temperature at will;
the heating of the aforementioned external surface 5 of said device.

A sensor is also installed to check the quantity of liquid remaining inside the tank 3 and to signal its possible absence by turning on a warning light.

The variable parameters, selected by the users, are the quantity and temperature of the liquid ejected, the softness or hardness of the entire device and its temperature; the emission of sounds and vibration.

These variants can be controlled via:
wireless connection means that allow connection to electronic devices such as, but not limited to, smartphones;
a dedicated software application which also allows the storage of a history of favorite uses and any other interaction activity between said device and a user;
a Bluetooth speaker reversibly separable from the entire device; which communicates with said software application.

1. An erotic device with realistic appearance of a phallus, adapted for ejecting a liquid by simulating an act of ejaculation, said erotic device being characterized in that it has realistic appearance and consistency and simulates an erectile and post-erectile phase; said erotic device comprising:
at least a central rod (2) having a phallic shape, including in its interior at least one cavernous element (2.1), adapted for allowing a transfer of said liquid, preferably water; wherein said cavernous element (2.1) further includes soft cavernous weaves, adapted for deforming themselves by simulating an erection and a volume increase, and after being emptied, simulating a post-ejaculatory turgidity loss; wherein said rod (2) is connected to a liquid ejection module (1) and to a lower liquid tank (3);
at least one liquid ejection module (1), having the shape of a glans, arranged at the top of said central rod (2) and including at least one reversibly openable aperture (1.1) arranged at the upper end of at least two overlapping cusps (1.2); wherein said cusps (1.2) are connected to said cavernous element (2.1) and are adapted for initially internally retaining said liquid, while allowing subsequently a liquid outflow in a controlled manner;
at least one lower liquid tank (3), having a scrotum shape and comprising at least one internal bag (3.1) adapted for liquid containment; wherein said tank (3) comprises at least one motor (3.4) which is lowerly arranged with respect to said rod (2) and is adapted to cause a transfer of said liquid from said inner bag (3.1) to said cavernous element (2.1); wherein said motor (3.4) comprises at least one micropump (3.5) with a lowerly arranged first end (3.2) apt to suck said liquid contained in said bag (3.1); wherein said micropump (3.5) comprises at least one second end (3.3) which is upperly arranged with respect to said motor (3.4) and is adapted for injecting said liquid into the cavernous element (2.1); wherein said motor (3.4) is operated by means of at least one reversibly extractable battery; wherein said tank (3) comprises on a lower surface thereof a small watertight cap (3.6) adapted for allowing said liquid to be refilled; said tank (3) having a scrotum-like appearance and being adapted, in analogy to said central rod (2), for reducing its volume upon emptying;
wherein said liquid ejection is activated when said cavernous element (2.1) applies a mechanical pressure on said motor (3.4) by performing a continuous movement from top to bottom and consequently permits the liquid outflow/ejection from the liquid ejection module (1) through said aperture (1.1); wherein said device has an outer surface (5) preferably made of soft silicon rubber and further includes at least one push-button adapted for turning said motor (3.4) on or off, by an on/off input command.

2. A device according to the preceding claim 1, characterized in that it comprises at least one rechargeable battery and at least one snap-fit battery charger; wherein said battery charger comprises LED lights which indicate the battery charge status.

3. A device according to claim 1, characterized in that said central rod (2) is internally provided with at least three cavernous elements (2.1) allowing to apply a threefold pressure on an upper side of said motor (3.4).

4. A device according to claim 1, characterized in that said outer surface (5) comprises a plurality of microLEDs adapted for making said outer surface (5) luminous and with variable colors.

5. A device according to claim 1, characterized in that said outer surface (5) is transparent or may be customized regarding its color by any user.

6. A device according to claim 1, characterized in that it contains a drinking liquid, and the latter's taste can be varied/selected by the user.

7. A device according to claim 1, characterized in that it comprises watertight seals at the transitions/connections between said liquid ejection module, said rod and said tank (1-2-3), said watertight seals being configured in such a way as to render said device completely waterproof.

8. A device according to claim 1, characterized in that it comprises a plurality of electrical resistances uniformly distributed within said tank (3), said central rod (2) and said liquid ejection module (1), and adapted for heating up said liquid to allow its ejection at a controlled temperature; wherein said electrical resistances are further adapted to possibly heat up the device's outer surface (5).

9. A device according to claim 1, characterized in that it comprises wireless connections to a portable electronic device, such as a smartphone; wherein said electronic device comprises a dedicated software application permitting to manage at least the amount and temperature of the ejected/delivered liquid, as well as the softness and hardness of the device as a whole, and its temperature, and permitting to store a history of its uses, and any other interaction activity between the device and any user.

10. A device according to claim 1, characterized in that it comprises at least one reversibly removable Bluetooth case adapted for communicating with any sort of last generation electronic device through a wireless connection.

11. A device according to claim 1, characterized in that it comprises at least one sensor, adapted for estimating the amount of liquid still present in the tank (3) and for reporting a possible lack of liquid by turning on a warning light.
